(19) United States
(12) Patent Application Publication
(10) Pub. No.: US 2025/0209885 A1
(43) Pub. Date: Jun. 26, 2025

(54) LOTTERY GAME MACHINE AND RECORDING MEDIUM

(71) Applicant: SEGA CORPORATION, Tokyo (JP)

(72) Inventors: Yoshiki Matsushita, Tokyo (JP); Tomio Kikuchi, Tokyo (JP)

(73) Assignee: SEGA CORPORATION, Tokyo (JP)

(21) Appl. No.: 19/077,791

(22) Filed: Mar. 12, 2025

Related U.S. Application Data
(63) Continuation of application No. PCT/JP2023/018358, filed on May 16, 2023.

(30) Foreign Application Priority Data
Sep. 14, 2022 (JP) 2022-146327

(51) Int. Cl. G07F 17/32; G07C 15/00

(52) U.S. Cl. CPC G07F 17/322; G07C 15/006; G07F 17/329; G07F 17/3209; G07F 17/3211

(57) ABSTRACT

A lottery game machine includes: satellites; a lottery board, onto which the lottery medium is fed in response to an operation input received from the satellites, comprises: ball pockets; and satellite holes formed in a periphery of the lottery board and respectively corresponding to the satellites; and a CPU that: executes a first lottery that determines a lottery result shared among all the satellites based on whether the lottery medium has entered any one of the ball pockets, executes a second lottery that determines one of the satellites associated with any one of the satellite holes that the lottery medium has entered, applies the lottery result of the first lottery to all game settings respectively corresponding to the satellites, and adjusts, among the game settings, a game setting corresponding to the one of the satellites.

### BACKGROUND

### Technical Field

The present invention relates to a lottery game machine and a recording medium storing instructions.

### Description of Related Art

Conventionally, lottery game machines provided with a lottery device that includes a turntable for conducting a physical lottery, and satellites (i.e., player terminals) that receive operation inputs from players participating in a lottery game have been known.

Regarding this type of lottery game machine, Patent Literature 1 listed below discloses an example of one such lottery game machine that conducts a lottery based on whether a ball fed onto a turntable having a plurality of holes has dropped into any one of the holes. With this lottery game machine, the number of the hole into which the ball drops is used as the lottery result, and a bingo game is executed by activating the corresponding number on a bingo card. CITATION LIST

### PATENT LITERATURE

Patent Literature 1: Japanese Patent No. 4193774

### Technological Problem to be Solved by the Invention

With the technique disclosed in Patent Literature 1, the lottery result is uniformly applied to all of the players whose operation inputs are received at each satellite, so the gameplay may become monotonous, and there is room for improvement in terms of enhancing the entertainment value of the lottery game.

### SUMMARY

One or more embodiments of the present invention provide a lottery game machine and a non-transitory computer readable recording medium storing instructions that enhance the entertainment value of a lottery game.

The lottery game machine according to a first aspect of the present invention executes a lottery game featuring a lottery medium, the lottery game machine comprising: a plurality of satellites, each of which receives an operation input from a player playing a game; a lottery board, onto which the lottery medium is fed in response to the operation input received from the satellites, comprising: ball pockets; and satellite holes formed in a periphery of the lottery board and respectively corresponding to the satellites; and a central processing unit (CPU) that: executes a first lottery that determines a lottery result shared among all the satellites based on whether the lottery medium has entered any one of the ball pockets, executes a second lottery that determines one of the satellites associated with any one of the satellite holes that the lottery medium has entered, applies the lottery result of the first lottery to all game settings respectively corresponding to the satellites, and adjusts, among the game settings, a game setting corresponding to the one of the satellites.

In the lottery game machine according to a second aspect of the present invention, each of the satellite holes is disposed in a vicinity of a corresponding satellite among the satellites.

In the lottery game machine according to a third aspect of the present invention, the lottery board comprises a protrusion in a center of the lottery board, the protrusion is movable in a direction intersecting an upper surface of the lottery board, the CPU controls movement of the protrusion in the intersecting direction, in a state where the protrusion is positioned flush with the upper surface of the lottery board, the protrusion functions as one of the ball pockets, and in a state where the protrusion is positioned protruding from the upper surface of the lottery board, the protrusion does not function as one of the ball pockets.

In the lottery game machine according to a fourth aspect of the present invention, the protrusion has one or more vanes, and the CPU rotates the protrusion protruding from the upper surface of the lottery board.

In the lottery game machine according to a fifth aspect of the present invention, the CPU controls movement of the satellite holes in a direction intersecting an upper surface of the periphery of the lottery board.

In the lottery game machine according to a sixth aspect of the present invention, the CPU executes the second lottery upon determining that a specific execution condition is met during execution of the first lottery.

A non-transitory computer readable recording medium storing instructions for controlling a lottery game machine that executes a lottery game featuring a lottery medium, the lottery game machine comprising: a plurality of satellites, each of which receives an operation input from a player playing a game; a lottery board, onto which the lottery medium is fed in response to the operation input received from the satellites, comprising: ball pockets; and satellite holes formed in a periphery of the lottery board and respectively corresponding to the satellites, the instructions causing the lottery game machine to execute: executing a first lottery that determines a lottery result shared among all the satellites based on whether the lottery medium has entered any one of the ball pockets; executing a second lottery that determines one of the satellites associated with any one of the satellite holes that the lottery medium has entered; applying the lottery result of the first lottery to all game settings corresponding to the satellites; and adjusting, among the game settings, a game setting corresponding to the one of the satellites.

With one or more embodiments of the present invention, it is possible to enhance the entertainment value of the lottery game.

### BRIEF DESCRIPTION OF THE DRAWINGS

FIG. 1 is an exterior perspective view of a lottery game machine according to a first embodiment;

FIG. 2 is a plan view of a lottery device and satellites in the lottery game machine of FIG. 1, as seen from above;

FIG. 3 is a diagram showing the protrusion when positioned flush with the upper surface of the turntable;

FIG. 4 is a diagram showing the protrusion when positioned protruding from the upper surface of the turntable;

FIG. 5 is a block diagram schematically showing an example of the hardware configuration of the lottery game machine;

FIG. 6 is a block diagram schematically showing an example of the functional configuration of the lottery game machine;

FIG. 7 is a flowchart showing an example of the flow of processing performed by each functional units of the lottery game machine 1 according to the first embodiment;

FIG. 8 is a diagram of bonus pockets when positioned flush with the upper surface of the guide ring;

FIG. 9 is a diagram of bonus pockets when positioned below the upper surface of the guide ring; and

FIG. 10 is a flowchart showing an example of the flow of processing performed by each functional units of the lottery game machine according to a second embodiment.

### DETAILED DESCRIPTION

A number of embodiments of the present invention will now be described with reference to the appended drawings. To facilitate understanding of the description, components and steps that are the same will be numbered the same as much as possible in the drawings, and redundant descriptions will be omitted.

### First Embodiment

A first embodiment will now be described.

### Overall Configuration

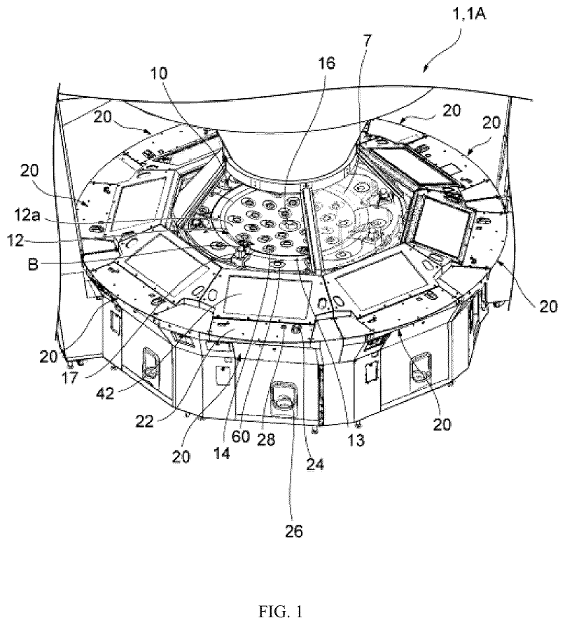

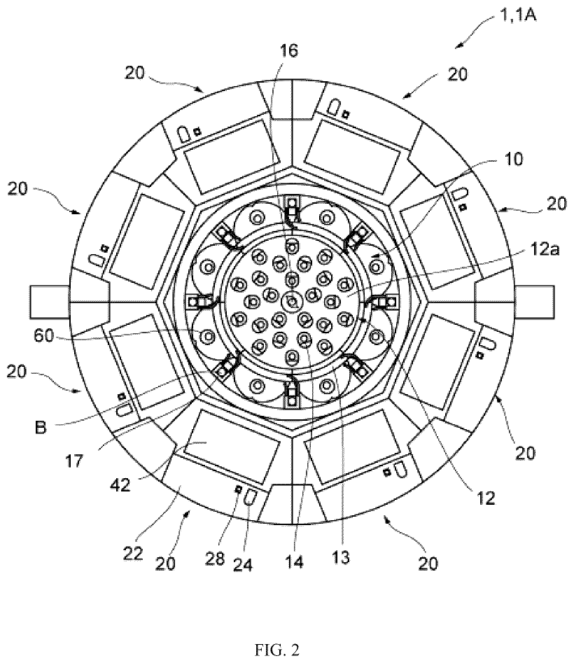

FIG. 1 is an exterior perspective view of a lottery game machine 1 according to the first embodiment. FIG. 2 is a plan view of a lottery device 10 and satellites 20 in the lottery game machine 1 of FIG. 1, as seen from above.

As shown in FIGS. 1 and 2, the lottery game machine 1 according to the first embodiment is an arcade game machine installed in a game center or the like, and is an information processing device that executes instructions such as a game program. The lottery game machine 1 provides a player of the lottery game machine 1 with a lottery game by outputting the execution result of the instructions (image data, audio data, etc.) to the lottery game machine 1. The lottery game machine 1 includes a physical lottery device 10 disposed in the center, and a plurality of satellites 20 (eight in the first embodiment) disposed around the lottery device 10, which serve as player terminals that receive operation inputs from players. The lottery game machine 1 executes a lottery game featuring a ball B as a lottery medium in the lottery device 10 in response to receiving operation inputs from players at each of the plurality of satellites 20.

The ball B used in the lottery game is, for example, a semi-transparent resin sphere, with each ball having unique information that differentiates it from other balls. This unique information may include, for example, appearance information such as at least one of the color, shape, or size of the ball B, or a tag ID, which is identification information indicating an IC tag (not shown) contained in the ball B. The IC tag is a small recording medium capable of recording unique information about the ball B, and may be embedded in the ball B, for example. The IC tag may be, for example, an RFID (radio frequency identification) tag. The ball B need not be translucent. Also, the shape of the ball B is not limited to a sphere, and may instead have a spindle shape like a rugby ball, for example. Also, the lottery medium is not limited to the ball B, and may instead be a polyhedral object formed by combining flat surfaces, such as a die, for example.

The lottery device 10 has a turntable 12, which is a lottery wheel (or lottery board) onto which a ball B is dropped. The turntable 12 has a curved disk shape, with shallow bowl-like recess or a concave hemispherical shape in its center, and can be rotated by a rotation drive mechanism (not shown). This rotation drive mechanism is, for example, a mechanism that supports the lower surface of the turntable 12 with a plurality of rollers that can be driven by a motor, and allows the turntable 12 to be rotated by driving the rollers with the motor. The upper surface 12a of the turntable 12 is a moving surface on which the ball B can move (roll). The ball B fed onto the turntable 12 gradually moves toward the center of the turntable 12 while rolling on the upper surface 12a of the rotating turntable 12. A guide ring 13 is provided around the turntable 12. Also, a plurality of transparent panels 7 are provided above the turntable 12. For ease of description, the transparent panel 7 on the front side in FIG. 1 is not depicted, but a transparent panel 7 would also be installed in that location on the actual machine.

The turntable 12 has formed in it a plurality of (e.g., 25) ball pockets 14 as holes that a ball B can enter. The ball pockets 14 are holes that the ball B can enter, or in other words, ball catching parts capable of catching the ball B. The plurality of ball pockets 14 are disposed on the turntable 12 in three concentric circles having different diameters. Each ball pocket 14 is provided with an infrared sensor (not shown), for example, as a detection mechanism for detecting the ball B that has entered the ball pocket 14. The infrared rays from this infrared sensor are blocked by the ball B when it enters the ball pocket 14, allowing the ball B to be detected. Also, this detection mechanism may be provided with an IC tag reader that detects an IC tag, and the IC tag reader of the ball pocket 14 in which a ball B is detected is operated to read (detect) the unique information about the ball B. The ball pockets 14 are associated with numbers, such as 1 to 25, and although not depicted in the drawings, these numbers are randomly assigned, with no duplication, in the vicinity of the ball pockets 14. Also, light-emitters (light-emitting members) (not shown) that emit light in a plurality of colors and are constituted by LEDs or the like are provided around (near) the ball pockets 14. These light-emitters are provided so as to surround the outer edges of the ball pockets 14, for example. There are no particular restrictions on the conditions for causing the light-emitters to emit light, but the light-emitters may simply emit light randomly as an electric decoration, or may emit light based on color information included in the unique information about the ball B. For instance, these light-emitters may be caused to emit light in the color of a ball B that is pre-associated with a ball pocket 14 during a lottery game, or may be caused to emit light in the color of that ball B at the point when the ball B enters the ball pocket 14. Also, as a condition for causing these light-emitters to emit light, it is possible to emit light ahead of time in a color corresponding to the satellite 20 or to the ball B that will be fed (ejected) from the satellite 20 onto the turntable 12 in the second lottery discussed below, thereby informing the player of which ball pocket 14 is associated with which satellite 20.

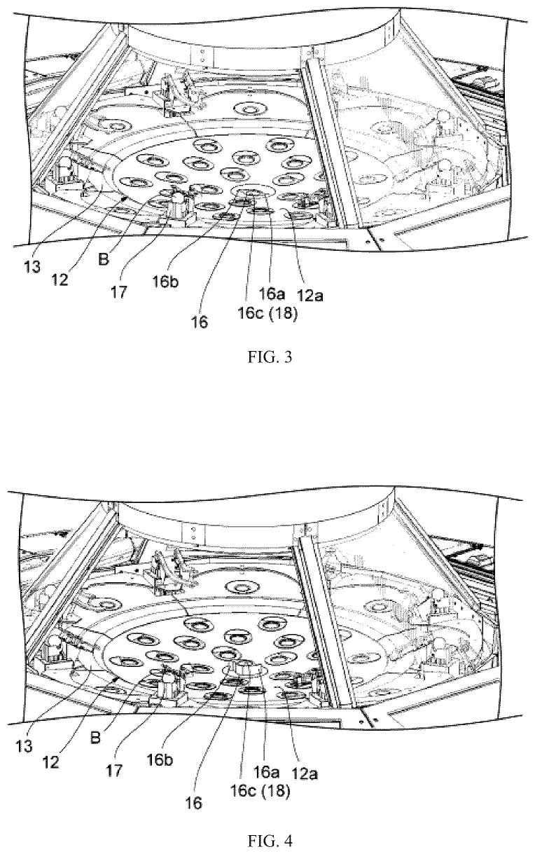

Also, a protrusion 16 is formed in the center of the turntable 12 so as to be able to move in a direction intersecting the upper surface 12a of the turntable 12 (the up and down direction). The protrusion 16 will be described in detail below with reference to FIGS. 3 and 4, which are detail views of the turntable 12. FIG. 3 is a diagram showing the protrusion 16 when positioned flush with the upper surface 12a of the turntable 12. FIG. 4 is a diagram showing the protrusion 16 when positioned protruding from the upper surface 12a of the turntable 12.

As shown in FIGS. 3 and 4, the protrusion 16 has one or more (a pair in this embodiment) vanes 16a and 16b, creating the shape of a pinwheel. Also, a hole 16c is formed in the upper surface of the protrusion 16 (the surface on the upper surface 12a side of the turntable 12). The protrusion 16 can move up and down by being driven by a motor (not shown) during the lottery game.

As shown in FIG. 3, when the protrusion 16 is positioned flush with the upper surface 12a of the turntable 12, the hole 16c formed in the protrusion 16 functions as one of the plurality of holes (ball catching parts) formed in the turntable 12. That is, when driven by a motor that moves the protrusion 16 downward, the protrusion 16 retracts so as not to protrude from the turntable 12, and a ball catching part (central hole) appears in the center of the turntable 12. Hereinafter, the hole 16c that functions as a ball catching part will be referred to as the “center pocket 18.” In addition, the center pocket 18 may be provided with an infrared sensor, for example, as a ball detection mechanism, similar to the ball pockets 14 described above.

In contrast, as shown in FIG. 4, when the protrusion 16 is positioned protruding from the upper surface 12a of the turntable 12, the hole 16c does not function as one of the plurality of holes (ball catching parts) formed in the turntable 12. That is, when driven by the motor that moves the protrusion 16 upward, the protrusion 16 protrudes from the turntable 12, and the ball catching part disappears from the center of the turntable 12. Also, in this state, the protrusion 16 can be rotated by the drive of a motor (not shown). The rotation direction of this protrusion 16 may be, for example, a rotation direction that matches the rotation direction of the turntable 12 (the same rotation direction as the turntable 12), and the rotation speed of this protrusion 16 may be, for example, a rotation speed higher than the rotation speed of the turntable 12. This rotating protrusion 16 has the function of flicking a ball B that has rolled to the center of the turntable 12 toward the outside of the turntable 12 (toward the guide ring 13) by the vanes 16a and 16b. Hereinafter, when rotating in this manner, the protrusion 16 will be referred to as a “rotating pinwheel 19.” The rotation of the protrusion 16 is not limited to the above example, and the rotation may be in the opposite direction from the rotation direction of the turntable 12, for example. In this way, it is possible to deflect a ball B rolling on the turntable 12 with force. Also, the rotation of the protrusion 16 may be any type of rotation as long as it is capable of flicking the ball B, and there are no restrictions on the direction and speed of rotation or the like. For example, the rotation axis of the protrusion 16 may be offset from the rotation axis of the turntable 12, or the rotation axis of the protrusion 16 may be oriented in a direction intersecting the rotation axis of the turntable 12. Also, the rotation speed of the protrusion 16 may be lower than the rotation speed of the turntable 12.

Also, under the turntable 12 is provided a ball handling mechanism (not shown) that performs various kinds of processing on a ball B that has entered any one of the ball pockets 14 or the center pocket 18. This ball handling mechanism includes a ball collection mechanism, a ball identification mechanism, a ball selection mechanism, a ball feed mechanism, etc.

The ball collection mechanism collects balls B that have entered any one of the ball pockets 14 or the center pocket 18. The ball collection mechanism is constituted by, for example, a collection box in which balls B that have entered any one of the ball pockets 14 or the center pocket 18 are collected, a flap that opens and closes a hole formed between a ball pocket 14 and the collection box, a solenoid that drives the flap, and so forth. The ball collection mechanism opens the hole formed between the ball pocket 14 and the collection box by driving the flap at a specific timing, and collects the ball B from the ball pocket 14. Also, a ball B that has entered the center pocket 18 drops directly into the collection box, for example, and is collected by the ball collection mechanism without the flap needing to be driven.

Also, the ball identification mechanism identifies unique information such as the color of the balls B collected by the ball collection mechanism. The ball identification mechanism is constituted by an IC tag reader that detects unique information such as the color of the collected balls B, a guide path that guides the collected balls B to the ball selection mechanism, a motor for rotating a rotary disk that sends out a ball B along the guide path, and so forth.

Also, the ball selection mechanism sorts the balls B identified by the ball identification mechanism according to unique information such as color, and selects a ball B to be fed. The ball selection mechanism is constituted by, for example, a guide path that directs the identified ball B to the ball feed mechanism according to unique information such as color, a motor for rotating the rotary disk that sends out the ball B along the guide path, and so forth.

Also, the ball feed mechanism feeds the ball B selected by the ball selection mechanism onto the turntable 12. The ball feed mechanism is constituted by, for example, an elevator device that lifts the ball B received from the guide path of the ball selection mechanism from the lower side to the upper side of the guide ring 13, a feed chute 17 for feeding the ball B lifted by the elevator device from the guide ring 13 side onto the turntable 12, and so forth. In the first embodiment, a plurality of ball feed mechanisms including the feed chute 17 are provided for each satellite 20. This ball feed mechanism need not be provided to every satellite 20, so long as at least one ball feed mechanism is provided to the lottery game machine 1. That is, the ball feed mechanism may be shared by the satellites 20.

Returning to FIGS. 1 and 2, eight satellites 20 are arranged around the lottery device 10. A satellite 20 is an operating station that is faced and operated by a player, and that receives operation inputs from a player participating in a lottery game. The eight satellites 20 may be colored differently from one another (in colors corresponding to the eight possible colors that a ball B can be colored), for example. Each satellite 20 has a console 22 that includes a touch panel 42. The console 22 is provided with a token insertion slot 24, a token payout slot 26, operation buttons 28, etc. The console 22 may also be provided with a card reader or the like that reads information about the player from an amusement IC card owned by the player.

### Hardware Configuration

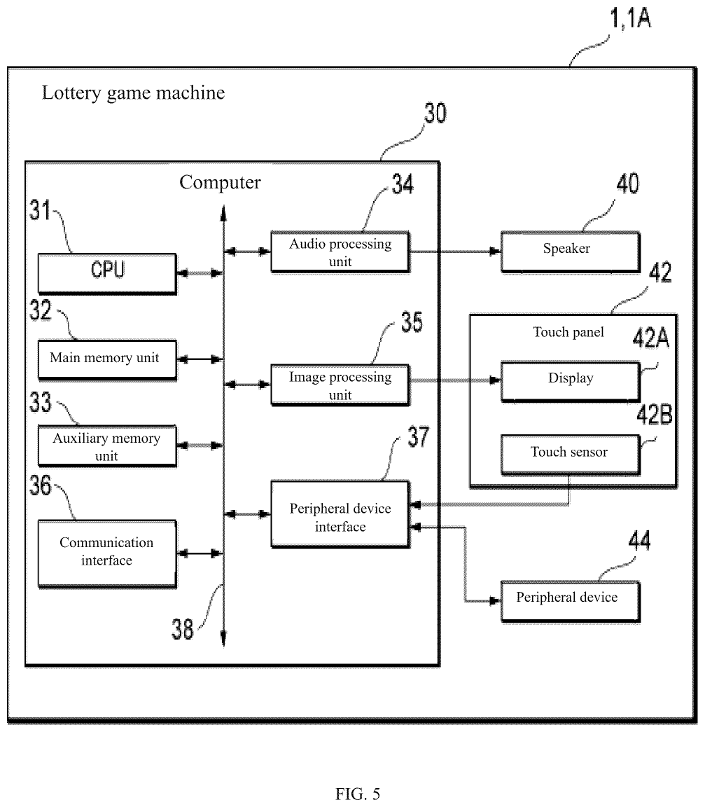

FIG. 5 is a block diagram that schematically shows an example of the hardware configuration of the lottery game machine 1.

As shown in FIG. 5, the lottery game machine 1 includes a computer 30, a speaker 40, a touch panel 42, and peripheral devices 44.

The computer 30 has a central processing unit (CPU) 31, a main memory unit 32, an auxiliary memory unit 33, an audio processing unit 34, an image processing unit 35, a communication interface 36, a peripheral device interface 37, and a system bus 38 that connects these units.

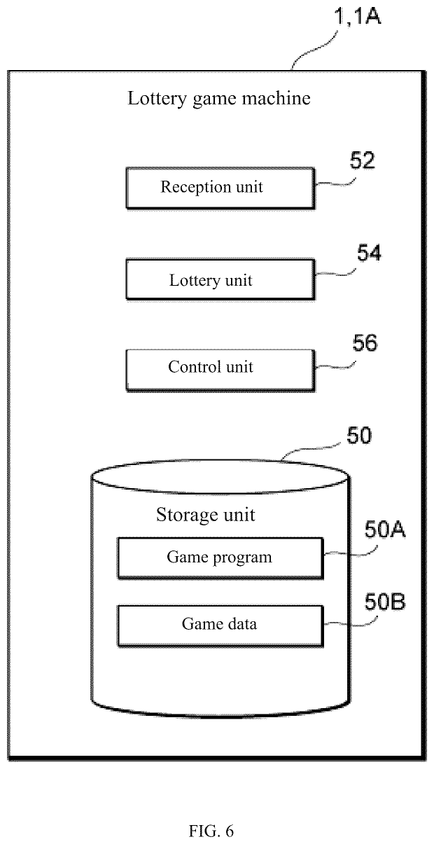

The CPU 31 controls the overall lottery game machine 1. The main memory unit 32 is constituted by a random access memory (RAM) and a read-only memory (ROM). The auxiliary memory unit 33 is constituted by a hard disk or the like. The main memory unit 32 and the auxiliary memory unit 33 store various kinds of instructions and various kinds of information necessary for executing processing by the CPU 31 as well as information about processing results. The CPU 31 executes a specific instruction stored in the main memory unit 32, the auxiliary memory unit 33, etc., and other hardware operates under the control of the CPU 31 to realize various functional configurations of the lottery game machine 1 (see FIG. 6).

The audio processing unit 34 performs various kinds of sound processing. The image processing unit 35 performs various kinds of graphic processing. The communication interface 36 allows the lottery game machine 1 to communicate with an external server device or other game devices. The peripheral device interface 37 allows for communication with the touch sensor 42B of the touch panel 42 and other peripheral devices 44.

The speaker 40 is a sound output device that outputs game sounds, etc.

The touch panel 42 is an image display device that displays a game screen, etc. The touch panel 42 has the functions of both a display device and an input device and is constituted by a display 42A, which serves as the display device, and a touch sensor 42B, which serves as the input device. The display 42A is constituted by an ordinary display device such as a liquid crystal display or an organic EL (electro-luminescence) display.

The touch sensor 42B is an operation input device for inputting operations by the player and is constituted by elements for detecting a touch operation on the screen displayed by the display 42A. The touch operation detection method employed by the touch sensor 42B can be any known method, such as a capacitance method, a resistive film method (pressure sensitive method), or an electromagnetic induction method. The touch sensor 42B receives the operation inputs from the player by detecting operations made with the player's finger, a stylus, or another such object that is used to touch the screen. The operation input device for inputting operations by the player is not limited to the touch sensor 42B, and may be any component that allows the player to input operations, such as by using the operation buttons 28 or a joystick.

The peripheral devices 44 are provided to the lottery game machine 1 and are controlled by the computer 30 via communication with the computer 30. These devices include various sensors, IC tag readers, motors, solenoids, etc., that are provided to the lottery device 10 and the satellites 20.

FIG. 5 merely shows the main components of the lottery game machine 1, and the lottery game machine 1 may also include other components that are included in a typical arcade game machine. Also, the computer 30 of the lottery game machine 1 is not limited to the configuration described above, and other components that are included in an information processing device, such as a dedicated or general-purpose computer, may be provided.

### Game Overview

There are no particular limitations on the lottery game executed by the lottery game machine 1 according to the first embodiment, but as an example, a case will be described in which this lottery game is a token game that includes a bingo game and a player battle game. Here, an overview of the bingo game and the player battle game will be given.

The lottery game machine 1 executes a bingo game as the normal game executed during normal play. This bingo game involves the use of a bingo card, which is a grid in which numbers are arranged in five rows and five columns, for example. The information arranged on the bingo card is not limited to numbers, and any identification information such as symbols or pictures may also be used. When a bingo game is played, the display 42A displays a bingo card on which numbers are arranged according to arrangement information assigned to each satellite 20 (player), as the play screen of the bingo game. When the bingo game starts, a plurality of balls B are fed from the feed chute 17 onto the turntable 12, either sequentially or all at once. Then, a lottery is carried out based on whether the balls B that were fed entered any one of the ball pockets 14 or the center pocket 18. With this lottery, for example, the number associated with the ball pocket 14 into which a ball B drops is determined as the shared lottery result for all the satellites 20. The determined number is then activated and displayed on the display 42A in a format that makes it stand out from other numbers. This process of selecting numbers through the lottery and activating the selected numbers is repeated a number of times, and when the activated numbers on the bingo card are arranged in a specific sequence, such as vertically, horizontally, or diagonally, bingo is achieved (a win).

Also, the lottery game machine 1 executes a player battle game as a special game (bonus game) that begins spontaneously when a specific game switching condition, such as an event occurrence, is satisfied during the execution of the normal game. When a player battle game is being executed, information indicating that a player battle is underway, for example, is displayed on the display 42A as the play screen of the player battle game. A player battle game is a game in which, for example, players whose operation inputs are received at each satellite 20 compete against each other using balls B of the color associated with the player's own satellite 20 as their proxy. When the player battle game begins, eight balls B corresponding to one of the eight colors associated with the satellites 20 are fed all at once from the feed chute 17 onto the turntable 12. A lottery is then carried out based on whether the balls B that were fed have entered any one of the ball pockets 14 or the center pocket 18. In this lottery, the satellite 20 associated with the color of a ball B that satisfies a specific lottery condition is determined. Next, the game or game setting of the determined satellite 20 is favored or disfavored. For example, the game result may be that, out of the eight balls B fed all at once, the satellite 20 associated with the color of the ball B that avoids entering either a ball pocket 14 or the center pocket 18 the longest is considered the winner, and the other satellites 20 are considered to be losers. The special game is not limited to a player battle game such as this, and may instead be a special bingo game that is different from a normal bingo game, or a game other than a bingo game.

### Functional Configuration

FIG. 6 is a block diagram schematically showing an example of the functional configuration of the lottery game machine 1.

As shown in FIG. 6, the lottery game machine 1 comprises, as functional components, a storage unit 50, a reception unit 52, a lottery unit 54, and a control unit 56.

The storage unit 50 is realized in the form of one or more auxiliary memory units 33. Functional components other than the storage unit 50 are realized when the CPU 31 executes instructions including a game program 50A stored in the main memory unit 32, the auxiliary memory unit 33, etc. In addition, some or all of these functional components included in the lottery game machine 1 may be provided to an external server device or the like. For example, the storage unit 50, the control unit 56, etc., may be provided to an external server device or the like. The storage unit 50 stores the instructions and game data 50B, for example.

The game program 50A is a program for providing the computer 30 with various functions for executing a lottery game. The instructions including such program may be stored in an external storage device or the like of the lottery game machine 1. Also, the instructions may be provided by being recorded on a computer-readable recording medium, or may be provided in a format that can be installed via a network such as the Internet.

The game data 50B comprises various kinds of data necessary for the computer 30 to carry out a lottery game. The game data 50B is set in advance by the game designer, for example. The game data 50B may include, for example, association information linking each satellite 20 with unique information about a ball B, or association information linking the ball pockets 14 with numbers in the bingo game. The association information linking each satellite 20 with unique information about a ball B may include, for example, a satellite ID (identification information) indicating each satellite 20, and the color (unique information) of the ball B associated with that satellite ID. Each satellite ID is associated with a different color. Also, the association information linking the ball pockets 14 with numbers in the bingo game may include, for example, a pocket ID (identification information) indicating each ball pocket 14, and the number associated with that pocket ID. Each pocket ID is associated with a different number.

The reception unit 52 receives operations from players at the plurality of satellites 20. For instance, the reception unit 52 may receive an operation from a player indicating an instruction to start a lottery game. As an example of such an operation, a player facing a satellite 20 may insert (bet) the desired number of tokens into the token insertion slot 24. When tokens are inserted into the token insertion slot 24, a sensor provided to the token insertion slot 24 detects those tokens, and the detected result is outputted to the peripheral device interface 37. When the detected result is outputted to the peripheral device interface 37, the reception unit 52 receives the operation of tokens being inserted by the player. Then, when the reception unit 52 receives this operation, it outputs information indicating an instruction to start a lottery game to the control unit 56, together with a satellite ID indicating the satellite 20 that received the operation, a player ID indicating the player who performed the operation, etc. In addition, if the number of players participating in the lottery game is fewer than the number of satellites 20, the reception unit 52 may receive an instruction to start the lottery game through automatic control by the CPU 31. For example, at any satellite 20 where no player operation inputs have been received, the reception unit 52 may assume an instruction has been received to start a lottery game through automatic control by the CPU 31 on behalf of a player.

When a ball B is fed onto the turntable 12 by the control unit 56, the lottery unit 54 executes a lottery based on whether the ball B has entered any one of the ball pockets 14 or the center pocket 18. More specifically, the lottery unit 54 executes, as the lottery, a normal lottery (first lottery) that determines a lottery result shared among all the satellites 20, and a special lottery (second lottery) that determines a satellite 20 associated with unique information about the ball B that satisfies a lottery condition. In the first embodiment, an example will be given in which the unique information about the ball B related to this special lottery is appearance information about the ball B, and in particular the color of the ball B.

A normal lottery is a lottery that determines a lottery result shared among all the satellites 20 (common to all the players whose operation inputs were received at the satellites 20) based on whether a ball B has entered any one of the ball pockets 14 or the center pocket 18. A normal lottery is, for example, a lottery (number lottery) that is executed by the control unit 56 while a bingo game is being played as a normal game, and determines the number to be activated on a bingo card.

For example, in a normal lottery, the lottery unit 54 determines that a win is when a ball B enters a ball pocket 14, and determines the number associated with that ball pocket 14 to be a shared number to be activated on all the satellites 20. More specifically, when the ball B that has entered the ball pocket 14 is detected by an infrared sensor or the like, the infrared sensor outputs that detection information to the peripheral device interface 37. When the detection information is outputted, the lottery unit 54 identifies the pocket ID of the ball pocket 14 that the ball B has entered. Then, the lottery unit 54 refers to the game data 50B and determines the number associated with the identified pocket ID as the number to be activated. In a normal lottery, if a ball B fails to enter any one of the ball pockets 14 and instead enters the center pocket 18, this is considered to be a loss. That is, in this case, the center pocket 18 functions as a losing hole in the lottery. The lottery unit 54 confirms the lottery result for one round of the bingo game (determines the five numbers to be activated on the bingo card) when a total of five balls B win, for example.

Also, a special lottery is a lottery (satellite lottery) that determines a satellite 20 associated with the color (unique information) of a ball B that satisfies a lottery condition based on whether a ball B has entered any one of a plurality of ball pockets 14 or the center pocket 18. A special lottery is executed, for example, when a player battle game is executed as a special game by the control unit 56, and a specific satellite 20 to be favored or disfavored is determined by the control unit 56 (discussed below).

For example, in a special lottery, the lottery unit 54 selects a ball B that satisfies a lottery condition from among the plurality of balls B fed onto the turntable 12. In this case, the number of balls B selected by the lottery unit 54 does not necessarily have to be one. For instance, if there are a plurality of balls B that satisfy the lottery condition, the lottery unit 54 may further select one or more balls B from among these balls B, or may select all of these balls B. The lottery unit 54 then determines the satellite 20 associated with the color of the selected ball B as the specific satellite 20.

The lottery conditions for the special lottery might be, for example, the ball B (1) being the first ball to enter any one of the holes (ball pockets 14 and center pocket 18); (2) being the last ball to enter any one of the holes (ball pockets 14 and center pocket 18); (3) being the last ball remaining on the turntable 12; or (4) being the last ball remaining on the turntable 12 and it enters a specific hole (e.g., the center pocket 18), for example. That is, in a special lottery, the center pocket 18 can function as the winning hole in the lottery. In addition, in a special lottery, the center pocket 18 may function as a losing hole in the lottery, just like in a normal lottery. Also, the lottery conditions for the special lottery are not limited to one of the conditions (1) to (4) above, and various conditions may be set as appropriate by the game designer, etc. For instance, the ball pockets 14 may be divided into winning holes and losing holes, and winning holes may be set that correspond to the color of the selected ball B. When winning holes that correspond to the color of the selected ball B are set, the lottery conditions may include, for example, a condition that a ball B of a color that corresponds to the winning holes enters a winning hole.

The lottery unit 54 selects the ball B that satisfies the lottery condition based on detection information outputted to the peripheral device interface 37 from the IC tag reader or the like that serves as the ball detection mechanism, for example. For instance, the ball B detected first by the IC tag reader is selected as the ball that satisfies the lottery condition (1) above. Or, for example, the ball B detected last by the IC tag reader is selected as the ball that satisfies the lottery condition (2) above. Alternatively, for example, if seven balls B have been detected by the IC tag reader, the undetected ball B is selected as the ball that satisfies the lottery condition (3) above. Or, for example, the ball B that was not detected by any of the infrared sensors in any of ball pockets 14 and then detected last by the IC tag reader is selected as the ball that satisfies the above lottery condition (4).

The lottery unit 54 then specifies the color of the ball B that satisfies the lottery condition based on the detection information outputted from the IC tag reader to the peripheral device interface 37. The lottery unit 54 then refers to the game data 50B and determines the satellite 20 (satellite ID) associated with the information indicating the identified color. The lottery unit 54 confirms the lottery result for one round of the player battle game when all eight of the balls B that were fed have entered the ball pockets 14 or the center pocket 18.

Also, the lottery condition for the special lottery may differ depending on whether the protrusion 16 functions as one of the plurality of holes (ball catching parts) formed in the turntable 12. That is, the lottery condition may differ depending on whether the center pocket 18 appears on the turntable 12. For example, the lottery condition may be a condition related to the center pocket 18 when the center pocket 18 is present, and a condition unrelated to the center pocket 18 when the center pocket 18 is not present. The conditions related to the center pocket 18 may be, for example, the condition that the ball B is the first ball to enter the center pocket 18, that the ball is the last ball to enter the center pocket 18, that the ball B is the last ball remaining on the turntable 12 and that it enters the center pocket 18, etc. Conditions unrelated to the center pocket 18 may be the condition that the ball B is the first ball to enter any one of the ball pockets 14, that the ball B is the last ball to enter any one of the ball pockets 14, that the ball B is the last ball remaining on the turntable 12, that the ball B is the last ball remaining on the turntable 12 and that it enters a specific ball pocket 14, etc.

Also, the lottery unit 54 executes a special lottery when a specific execution condition is satisfied during the execution of a normal lottery. In the first embodiment, this execution condition may include, for example, that a specific event has occurred, that a specific length of time has elapsed, or that there was an operation by an administrator of the lottery game machine 1 (a staff member at the game center). There are no particular restrictions on the specific event, but it could be when, for example, a fifth ball B has entered the ball pocket 14 numbered “25,” or other such event.

In the first embodiment, it is assumed that the execution condition of this special lottery matches the switching condition for switching the lottery game from a normal game to a special game by the control unit 56. Also, in the first embodiment, when this execution condition is satisfied, the normal lottery is ended and switched to a special lottery. That is, in the first embodiment, the normal lottery is switched to a special lottery at the point when the normal game was switched to a special game. The player may learn of (preview) the execution conditions and switching conditions by looking at what is displayed on a display 42A, etc.

The control unit 56 controls the overall operation of the game executed on the lottery game machine 1. The control unit 56, for example, causes the display 42A of each satellite 20 to display a bingo card before receiving an operation from a player indicating an instruction to start a lottery game. Also, when the control unit 56 acquires information from the reception unit 52 indicating an instruction to start a lottery game at each of the satellites 20, the control unit 56 starts a normal game (bingo game) as the lottery game. More specifically, in response to the information outputted from the reception unit 52, the control unit 56 transmits a drive command to the motor for rotating the turntable 12 via the peripheral device interface 37. Consequently, the control unit 56 drives this motor to rotate the turntable 12. The control unit 56 also controls the ball handling mechanism so as to feed a plurality of balls B of a specific color onto the turntable 12 sequentially or all at once. In a normal bingo game, there is no particular restriction on the colors of the balls B that are fed, and the balls do not necessarily have to be eight colors.

Also, for example, the control unit 56 controls the ball handling mechanism to collect any balls B that have entered the center pocket 18 and feed them back onto the turntable 12. Also, if all of the balls B fed onto the turntable 12 have entered the ball pockets 14, the control unit 56 controls the ball handling mechanism so as to collect those balls B from the ball pockets 14, and then ends one round of the bingo game. The control unit 56 then controls the ball handling mechanism to so as feed the collected balls B again if the game is not over, and executes the next bingo game. If the game is over, the control unit 56 ends the lottery game without executing the next bingo game.

Also, if a switching condition for switching from the normal game to a special game is satisfied, the control unit 56 ends the normal game and switches to the execution of the special game (player battle game). In this case, the control unit 56 controls the ball feed mechanism so as to feed a plurality of balls B, each having a different color (unique information) and corresponding to the number of satellites 20, onto the turntable 12 all at once. Consequently, eight balls B of different colors (e.g., red, green, blue, purple, yellow, brown, black, and white) are fed onto the turntable 12 all at once.

Also, for example, the control unit 56 controls the ball handling mechanism so as to collect any balls B that have entered any one of the ball pockets 14 or the center pocket 18 during one round of the player battle game and to identify the colors of the collected balls B. Once all of the balls B that were fed have been collected and identified, the control unit 56 ends one round of the player battle game. The control unit 56 then controls the ball handling mechanism so as to feed the collected balls B again if the game is not over, and again executes a lottery game (either a normal bingo game or a player battle game). If the game is over, the control unit 56 ends the game without executing the next lottery game.

Also, the control unit 56 applies the shared lottery result determined by the normal lottery to all the games or game settings corresponding to all the satellites 20, and favors or disfavors the game (adjusts a game setting to be favored or disfavored) corresponding to the satellite 20 determined by the special lottery.

More specifically, the control unit 56 applies the shared lottery result determined by a normal lottery to the game at all the satellites 20 in a normal bingo game. The control unit 56 displays the numbers determined by the execution of the normal lottery on the bingo card displayed on the display 42A of each satellite 20 during the bingo game in a format that allows the numbers to be distinguished from other numbers.

Also, the control unit 56 favors or disfavors the game at the satellite 20 determined by the execution of a special lottery in the player battle game. Here, favoring a game includes conferring advantageous treatment, giving priority status, or granting benefits. Specific examples of favoring a game may include marking the game result as a win, performing various kinds of processing to make the game result more advantageous, granting benefits such as bonus games or jackpot games, or increasing the content used in the game such as characters and items. Conversely, disfavoring a game includes imposing disadvantages, subordinating, or reducing benefits. Specific examples of disfavoring a game may include marking the game result as a loss, imposing penalties such as performing various kinds of processing to make the game result less advantageous, or reducing the content used in the game such as characters and items. In addition, favoring or disfavoring a game is not limited to favoring or disfavoring a game result, and may also include favoring or disfavoring the progress of a game, such as during the course of the gameplay.

The control unit 56 may, for instance, favor or disfavor a satellite 20 determined by the execution of a special lottery relative to other satellites 20. In the first embodiment, the control unit 56 favors or disfavors only the game at the satellite 20 determined by a special lottery. For example, in a player battle game, the control unit 56 may impose a penalty on the satellite 20 associated with the color of the ball B that first enters one of a plurality of holes. Or, the control unit 56 may determine the game result to be a win for the satellite 20 associated with the color of the last ball B remaining on the turntable 12, and award a benefit such as a bonus game to that satellite 20. If the player wins this bonus game, for instance, an additional benefit such as a jackpot game may be further awarded. Also, the control unit 56 may determine the game result to be a big win (jackpot) for the satellite 20 associated with the color of the ball B that was the last ball remaining on the turntable 12 and that has entered the center pocket 18, and award a jackpot game benefit to that satellite 20. At the satellite 20 where this big win has occurred, a jackpot game benefit may be awarded directly even if the bonus game was not won. In other words, if there is a big win, the game result will be more favorable than if there is a simple win.

Also, the control unit 56 drives a motor for moving the protrusion 16 up and down during the lottery game. Consequently, the control unit 56 controls the movement of the protrusion 16 in a direction intersecting the upper surface 12a of the turntable 12. Controlling the movement of the protrusion 16 with the control unit 56 allows the protrusion 16 to move up or down. Consequently, when the protrusion 16 is positioned flush with the upper surface 12a of the turntable 12 (see FIG. 3), the center pocket 18 that functions as a ball catching part appears in the center of the turntable 12. By contrast, when the protrusion 16 is positioned so as to protrude from the upper surface 12a of the turntable 12 (see FIG. 4), the center pocket 18 disappears, thereby disabling its function as a ball catching part at the center of the turntable 12.

Also, the control unit 56 moves the protrusion 16 up or down according to a specific movement condition that is a condition for moving the protrusion 16, thereby making the center pocket 18 either appear or disappear. There are no particular restrictions on the movement condition, but examples may include a condition related to the number of balls B on the turntable 12, or a condition related to the game duration. The condition related to the number of balls B on the turntable 12 may be, for example, that the number of balls B on the turntable 12 has decreased to a specific number (e.g., three) or fewer. The condition related to the game duration may be, for example, that a specific amount of time has elapsed since the balls B were fed onto the turntable 12 in the lottery game. The control unit 56 moves the protrusion 16 upward to make the center pocket 18 appear, or moves the protrusion 16 downward to make the center pocket 18 disappear, at the point when such a movement condition is satisfied.

Also, the control unit 56 drives a motor for rotating the protrusion 16 in a state in which the protrusion 16 protrudes from the upper surface 12a of the turntable 12. Consequently, the control unit 56 rotates the protrusion 16 protruding from the upper surface 12a of the turntable 12 in the rotation direction of the turntable 12. The control unit 56 may, for example, rotate the protrusion 16 in the same direction as the rotation direction of the turntable 12 and at a speed higher than the rotation speed of the turntable 12. Consequently, the center pocket 18 disappears from the turntable 12 and the rotating pinwheel 19 appears instead. This rotating pinwheel 19 makes it possible to flick a ball B that has rolled to the center of the turntable 12 outward.

Also, in the second lottery, the control unit 56 conveys information to the player indicating which satellite 20 each of the plurality of holes (ball pockets 14 and center pocket 18) is associated with. For example, when a second lottery is executed by the lottery unit 54, the control unit 56 preemptively illuminates the light-emitters provided around the ball pockets 14 in a color corresponding to a satellite 20 or to a ball B fed onto the turntable 12 from that satellite 20. For example, the control unit 56 causes each of the light-emitters of the plurality of ball pockets 14 to emit light in one of the eight colors associated with each of the satellites 20. This allows the player to know which satellite 20 each ball pocket 14 is associated with based on the color emitted by the light-emitters of that ball pocket 14. Here, for example, if a winning hole corresponding to the color of ball B has been set from among the plurality of the ball pockets 14, the player can watch the ball B on the turntable 12 with interest to see whether the ball B of the color associated with their satellite 20 will enter the winning hole corresponding to its color. In addition, the control unit 56 may cause all of the plurality of ball pockets 14 to light up in any of the eight colors associated with the satellites 20, or may cause a specific number of ball pockets 14 (e.g., eight) to light up rather than all of the plurality of ball pockets 14.

### Flow of Processing

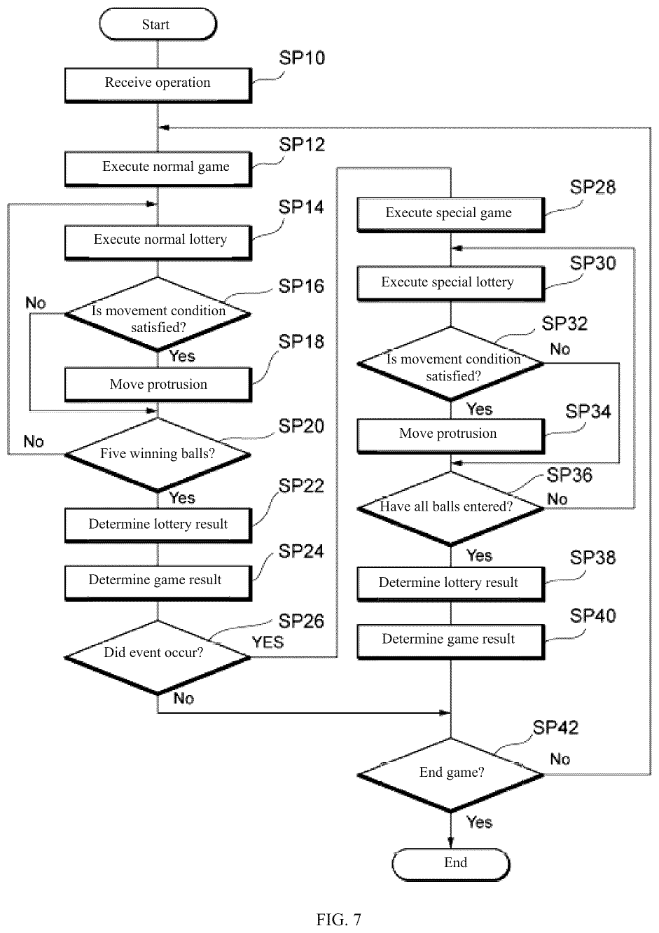

FIG. 7 is a flowchart showing an example of the flow of processing performed by each functional units of the lottery game machine 1 according to the first embodiment. The order and details of the following processing can be changed as needed. In the initial state (at the start of the lottery game) before the processing of FIG. 7 is started, a bingo card is displayed on the display 42A of each satellite 20.

### (Step SP10)

The reception unit 52 receives a token insertion (betting) operation from the player at each satellite 20 and outputs information indicating an instruction to start the lottery game to the control unit 56. The processing then moves to the processing of step SP12.

### (Step SP12)

The control unit 56 executes a bingo game as a normal game. Specifically, the control unit 56 sends a drive instruction to the motor for rotating the turntable 12, thereby driving the motor to rotate the turntable 12. Subsequently, the control unit 56 controls the ball handling mechanism to feed a plurality of balls B of a specific color onto the turntable 12, either sequentially or all at once. The processing then moves to the processing of step SP14.

### (Step SP14)

The lottery unit 54 executes a normal lottery to determine a lottery result shared among all the satellites 20 based on whether a ball B has entered any one of the ball pockets 14 or the center pocket 18. Additionally, if any balls B have entered the center pocket 18, the control unit 56 causes the ball handling mechanism to collect those balls B and feed them back onto the turntable 12. The processing then moves to the processing of step SP16.

### (Step SP16)

The control unit 56 determines whether the movement condition of the protrusion 16 is satisfied. For example, the control unit 56 determines whether the number of balls B on the turntable 12 has decreased to a specific number (e.g., three) or fewer. If this determination is affirmative, the processing moves to the processing of step SP18. If the determination is negative, the processing moves to the processing of step SP20. If, after an affirmative determination in the processing of step SP16 and proceeding through steps SP18 and SP20 and thereby returning to the processing of step SP14, and step SP16 is executed again, a determination may be made as to whether a different movement condition from that used in the previous affirmative determination is satisfied. For instance, the determination may be based on whether a movement condition is satisfied such as the number of balls B on the turntable 12 decreasing to an even smaller number (e.g., one) than the specific number (e.g., three).

### (Step SP18)

The control unit 56 drives the motor for moving the protrusion 16 up and down, causing the protrusion 16 to move. For example, when the center pocket 18 is present, the control unit 56 moves the protrusion 16 downward, thereby causing the center pocket 18 to disappear and the rotating pinwheel 19 to appear. Additionally, the control unit 56 drives the motor for rotating the rotating pinwheel 19, causing the rotating pinwheel 19 (protrusion 16) to rotate. Furthermore, when the rotating pinwheel 19 is present, the control unit 56 moves the protrusion 16 upward, thereby causing the rotating pinwheel 19 to disappear and the center pocket 18 to appear. The processing then moves to the processing of step SP20.

### (Step SP20)

The control unit 56 determines whether a total of five balls B have entered a ball pocket 14, resulting in a win. If the determination is affirmative, the processing moves to the processing of step SP22. If the determination is negative, the processing returns to the processing of step SP14, and the normal lottery is continued.

### (Step SP22)

The lottery unit 54 determines the numbers associated with the ball pockets 14 that the balls B entered (the five winning numbers) as the numbers to be activated in the bingo game. Additionally, the control unit 56 controls the ball handling mechanism to collect the balls B that entered the ball pockets 14 and prepares them for the next lottery game. The processing then moves to the processing of step SP24.

### (Step SP24)

The control unit 56 determines the game result for each satellite 20 based on the lottery result determined in step SP22. For example, the control unit 56 activates the five numbers determined in the processing of step SP22 on the bingo card displayed on the display 42A of each satellite 20. If the game result indicates that bingo has been achieved at a satellite 20, rewards such as tokens or bonus games are granted as prizes. Tokens granted as rewards are either dispensed at the token payout slot 26 of that satellite 20 or added to that satellite's credit balance by the control unit 56. The processing then moves to the processing of step SP26.

### (Step SP26)

The control unit 56 determines whether an event triggering the start of a special game (e.g., a fifth ball B has entered the ball pocket 14 numbered “25”) has occurred. If the determination is affirmative, the processing moves to the processing of step SP28, and if the determination is negative, the processing moves to the processing of step SP42.

### (Step SP28)

The control unit 56 executes a player battle game as a special game. Specifically, the control unit 56 controls the ball handling mechanism to feed eight balls B of eight different colors onto the turntable 12 all at once. The processing then moves to the processing of step SP30.

### (Step SP30)

The lottery unit 54 executes a special lottery to determine the satellite 20 associated with the color of a ball B that satisfies a lottery condition. Additionally, the control unit 56 controls the ball handling mechanism to collect the balls B that entered the ball pockets 14, identify the color of the collected balls B, and prepare them for the next lottery game. The processing then moves to the processing of step SP32.

### (Step SP32)

The control unit 56 determines whether a movement condition of the protrusion 16 is satisfied. This processing is the same as the processing in step SP16, and will not be described again. If the determination is affirmative, the processing moves to the processing of step SP34, and if the determination is negative, the processing moves to the processing of step SP36.

### (Step SP34)

The control unit 56 drives the motor for moving the protrusion 16 up and down, causing the protrusion 16 to move. This processing is the same as the processing in step SP18, and will not be described again. The processing then moves to the processing of step SP36.

### (Step SP36)

The control unit 56 determines whether all the balls B on the turntable 12 have entered any one of the ball pockets 14 or the center pocket 18. If the determination is affirmative, the processing moves to the processing of step SP38, and if the determination is negative, the processing returns to the processing of step SP30, and the special lottery is continued.

### (Step SP38)

The lottery unit 54 determines the lottery result of the special lottery. For example, if the center pocket 18 is not present, the lottery unit 54 selects the first ball B that enters any one of the plurality of ball pockets 14. The lottery unit 54 then determines the satellite 20 associated with the color of this selected ball B as the satellite 20 to be disfavored in the game result. On the other hand, if the center pocket 18 is present, the lottery unit 54 selects the last ball B remaining on the turntable 12 and that enters the center pocket 18 last. It then determines the satellite 20 associated with the color of this selected ball B as the satellite 20 to be favored in the game result. The processing then moves to the processing of step SP40.

### (Step SP40)

The control unit 56 determines the game result for each satellite 20 based on the lottery result determined in step SP38. For instance, the control unit 56 imposes a specific penalty on the satellite 20 determined in step SP38 to be disfavored. Conversely, the control unit 56 designates the satellite 20 determined in step SP38 to be favored in the game result as a big winner and awards a benefit to that satellite 20, such as a jackpot game. A player who wins in a jackpot game is awarded a large number of tokens as a reward. The awarded tokens are either dispensed from the token payout slot 26 of that satellite 20 or added to that player's credit balance by the control unit 56. The processing then moves to the processing of step SP42.

### (Step SP42)

The control unit 56 determines whether a game ending condition is satisfied such as game over. If the determination is affirmative, the processing ends the processing series shown in FIG. 7. If the determination is negative, the processing returns to the processing of step SP12, and the next normal game is carried out.

### Action and Effect

As described above, the lottery game machine 1 serving as the information processing device according to the first embodiment is a lottery game machine 1 that executes a lottery game featuring a ball B that is fed onto a turntable 12 in response to operation inputs received from players at each of a plurality of satellites 20, and comprises a lottery unit 54 for executing a normal lottery (first lottery) that determines a lottery result shared among all the satellites 20 based on whether the ball B has entered any one of ball pockets 14 or the center pocket 18 (a plurality of holes formed in the turntable 12), and a special lottery (second lottery) that determines the satellite 20 associated with the color, which is unique information about the ball B that satisfies a lottery condition, based on whether the ball B has entered any one of ball pockets 14 or the center pocket 18; and a control unit 56 that, based on the lottery result of the normal lottery, proceeds all the games corresponding to the satellites 20, and favors or disfavors the game at the satellite 20 determined by the special lottery.

With this configuration, a lottery result shared among all the satellites 20 is determined by a normal lottery, and the shared lottery result is applied to the game at each satellite 20. Also, the satellite 20 associated with the color of the ball B that satisfies the lottery condition is determined by a special lottery, and the game at that determined satellite 20 is favored or disfavored. Consequently, when a normal lottery is executed (in the case of a normal game), the lottery result shared among all the players is applied to the game, whereas when a special lottery is executed (in the case of a special game), the game is favored or disfavored only for a certain player. Thus, the gameplay can vary depending on whether a normal lottery or a special lottery is executed, which prevents the gameplay from becoming monotonous. Furthermore, when a special lottery is executed, it is possible to create a sense of anticipation or anxiety for the players, as only a certain player may be rewarded or penalized. It is therefore possible to enhance the entertainment value of the lottery game.

Also, with the lottery game machine 1 of the first embodiment, when a special lottery is executed, the control unit 56 feeds a plurality of balls B having different colors and corresponding to the number of satellites 20 onto the turntable 12, and when a special lottery is executed, the lottery unit 54 selects a ball B that satisfies the lottery condition from among the plurality of balls B, and determines the satellite 20 associated with the color of the selected ball B.

With this configuration, when a special lottery is executed, for example, with a lottery game machine 1 having eight satellites 20, eight balls B of eight colors are fed onto the turntable 12. This gives players a new way of playing, such as a player battle game, that is completely different from a normal bingo game and further enhances the entertainment value of the lottery game.

Also, with the lottery game machine 1 according to the first embodiment, the protrusion 16 that can move in a direction intersecting the upper surface 12a of the turntable 12 is formed in the center of the turntable 12, and the control unit 56 controls the movement of the protrusion 16 in the intersecting direction, and when the protrusion 16 is positioned flush with the upper surface 12a of the turntable 12 by the movement control, the protrusion 16 functions as one of the plurality of holes, and when the protrusion 16 is positioned protruding from the upper surface 12a of the turntable 12 by the movement control, the protrusion 16 does not function as one of the plurality of holes, and the lottery condition differs depending on whether the protrusion 16 will function as one of the plurality of holes.

With this configuration, moving the protrusion 16 up and down changes whether the protrusion 16 functions as one of the plurality of holes formed in the turntable 12. The lottery condition for a special lottery varies depending on whether the protrusion 16 functions as one of the plurality of holes, that is, whether the center pocket 18 appears, and the lottery result of the special lottery will therefore vary depending on the up and down movement of the protrusion 16. Consequently, the game can unfold in a variety of ways depending on the result of the special lottery.

Also, with the lottery game machine 1 according to the first embodiment, the protrusion 16 has the pair of vanes 16a and 16b, and the control unit 56 rotates the protrusion 16 protruding from the upper surface 12a of the turntable 12.

With this configuration, as the protrusion 16 protruding from the upper surface 12a of the turntable 12 rotates, the ball B hits the vanes 16a and 16b of the protrusion 16 and is flicked away. This makes it possible to introduce more variability into the movement of the ball B on the turntable 12, allowing for more diversity in the gameplay.

Also, with the lottery game machine 1 according to the first embodiment, the lottery unit 54 executes a special lottery when a specific execution condition is satisfied during the execution of a normal lottery.

With this configuration, when a specific execution condition such as an event occurrence is satisfied during the execution of a normal lottery in which a shared lottery result is obtained at all the satellites 20, a special lottery is executed to select a satellite 20 at which the game will be favored or disfavored. This creates a sense of exclusivity that the special lottery is something special that is different from a normal lottery.

Also, with the lottery game machine 1 according to the first embodiment, the unique information about the ball B is appearance information including at least one of the color, shape, and size of the ball B.

With this configuration, since the unique information about the ball B is appearance information that can be identified by eye, a player can visually identify the ball B having the unique information associated with the player's own satellite 20 among the balls B fed onto the turntable 12. Consequently, the player can predict whether the ball B with the unique information associated with their own satellite 20 will satisfy the lottery condition by looking at the movement of the ball B on the turntable 12, and this increases the player's excitement.

Also, with the lottery game machine 1 according to the first embodiment, the control unit 56 conveys information to the player indicating which satellite 20 the ball pockets 14 (the plurality of holes) are associated with in the second lottery.

With this configuration, the player can learn which satellite 20 a ball pocket 14 is associated with. Consequently, when a winning hole corresponding to the color of the ball B is set among the ball pockets 14, for example, the player will watch the movement of ball B on the turntable 12 with excitement to see whether the ball B of the color associated with their satellite 20 will go into the winning hole corresponding to the color of ball B.

### Second Embodiment

Next, the lottery game machine 1A according to a second embodiment will be described (see FIG. 1).

### Overall Configuration

The lottery game machine 1A according to a second embodiment will be described in detail, focusing primarily on the differences from the first embodiment. Aspects of the configuration and functions of the lottery game machine 1A according to the second embodiment are the same as those of the lottery game machine 1 according to the first embodiment.

In the first embodiment, an example was given in which the special lottery was a lottery that determined the satellite 20 associated with the color of the ball B that satisfied a lottery condition. In contrast, in the second embodiment, the special lottery is a lottery that determines the satellite 20 for which the ball B has entered a bonus pocket 60 (satellite hole) formed in the turntable 12. In the first embodiment, an example was given in which the lottery unit 54 executed a normal lottery in a normal game, and switched from the normal lottery to execute a special lottery in a special game. In contrast, in the second embodiment, the lottery unit 54 executes a normal lottery and a special lottery in parallel in the normal game.

First, the bonus pockets 60 formed on the turntable 12 will be described. As shown in FIGS. 1 and 2, bonus pockets 60 are formed around the periphery of the turntable 12 and are associated with each satellite 20. That is, each bonus pocket 60 is associated with each satellite 20. The bonus pockets 60 are disposed, for example, on the guide ring 13 around the periphery of the turntable 12, near the satellite 20 with which that bonus pocket 60 is associated. Here, “near the satellite 20” means near the position of the satellite 20. The bonus pockets 60 correspond to the number of satellites 20, so a total of eight are provided.

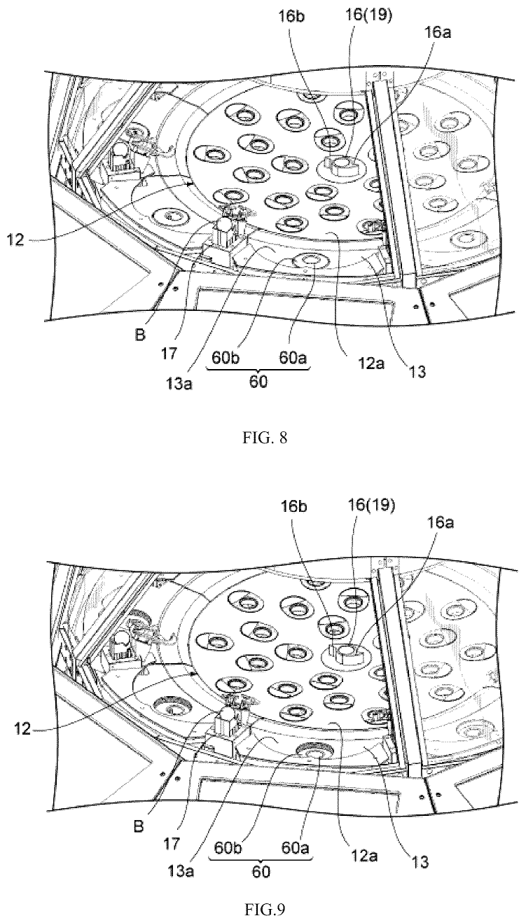

FIG. 8 is a diagram of the bonus pockets 60 when positioned flush with the upper surface 13a of the guide ring 13. FIG. 9 is a diagram of the bonus pockets 60 when positioned below the upper surface 13a of the guide ring 13.

As shown in FIGS. 8 and 9, the bonus pockets 60 each have a central portion 60a and an outer peripheral portion 60b. The central portion 60a and the outer peripheral portion 60b can each be moved up and down under the drive of a motor (not shown). The central portion 60a and the outer peripheral portion 60b may move up and down independently of each other, or may move up and down integrally. The ease with which a ball B can enter a bonus pocket 60 can be adjusted incrementally by moving the central portion 60a and the outer peripheral portion 60b of the bonus pocket 60 up or down. The bonus pockets 60, like the ball pockets 14, are provided with infrared sensors or the like as ball detection mechanisms.

As shown in FIG. 8, when the central portion 60a and the outer peripheral portion 60b of a bonus pocket 60 are positioned flush with the upper surface 13a of the guide ring 13, the bonus pocket 60 (particularly the central portion 60a) will not function as a ball catching part. In other words, the ball B cannot enter the bonus pocket 60.

In contrast, as shown in FIG. 9, when the central portion 60a and the outer peripheral portion 60b of the bonus pocket 60 are positioned below the upper surface 13a of the guide ring 13, the bonus pocket 60 (particularly the central portion 60a) will function as a ball catching part. That is, the ball B can enter the bonus pocket 60. Also, a ball B that has entered a bonus pocket 60 in this state is returned to the turntable 12 when the bonus pocket 60 is again positioned as shown in FIG. 8. This prevents the number of balls B involved in the lottery from decreasing even if a ball B enters a bonus pocket 60. In FIGS. 8 and 9, the upper surfaces of the central portion 60a and the outer peripheral portion 60b are located in approximately the same plane (are at the same height), but the upper surfaces of the central portion 60a and the outer peripheral portion 60b may be offset with respect to each other when the central portion 60a and the outer peripheral portion 60b move independently.

### Functional Configuration

The lottery game machine 1A has the same functional configuration as the first embodiment (see FIG. 6).

In the lottery game machine 1A, the game data 50B stored in the storage unit 50 further includes, in addition to or instead of the association information between the satellite 20 and the unique information about the ball B, association information between the satellite 20 and the bonus pockets 60. This association information includes a satellite ID (identification information) indicating each satellite 20, and a pocket ID (identification information) indicating the bonus pocket 60 associated with that satellite ID.

The lottery unit 54 executes a normal lottery (first lottery) that determines a lottery result shared among all of the satellites 20 based on whether balls have entered any one of the ball pockets 14 or the center pocket 18 formed on the turntable 12, and a special lottery (second lottery) that determines the satellite 20 associated with the bonus pocket 60 that a ball B has entered if a ball B has entered a bonus pocket 60. The normal lottery in the second embodiment is the same as the normal lottery in the first embodiment, and will not be described again.

The special lottery in the second embodiment is executed in parallel with a normal lottery, such as when a normal bingo game is executed. The special lottery is a lottery that determines the satellite 20 associated with the bonus pocket 60 that a ball B has entered as the satellite 20 that will be favored or disfavored in the bingo game. A ball B on the turntable 12 can enter a bonus pocket 60 formed in the guide ring 13 by, for example, being flicked by the rotating pinwheel 19. When a ball B that has entered a bonus pocket 60 is detected by an infrared sensor or the like, the infrared sensor outputs this detection information to the peripheral device interface 37. When this detection information is outputted, the lottery unit 54 specifies the pocket ID of the bonus pocket 60 that the ball B has entered. Then, the lottery unit 54 refers to the game data 50B and determines the satellite 20 (satellite ID) associated with the identified pocket ID.

Also, the lottery unit 54 executes a special lottery when a specific execution condition is satisfied during the execution of a normal lottery. In the second embodiment, this execution condition may include, for example, that a specific event has occurred, that a specific length of time has elapsed, or that there was an operation by an administrator of the lottery game machine 1 (a staff member at a game center). There are no particular restrictions on the specific event, but it could be when, for example, a ball B has entered a ball pocket 14 with a specific number, such as “8” or “16,” or other such event. In the second embodiment, the lottery unit 54 further executes a special lottery when the execution condition is satisfied during the execution of a normal lottery. The players may learn of (preview) this actual condition by it being displayed on the display 42A, etc.

Also, in a bingo game, the control unit 56 applies the result (number) of the normal lottery to all the satellites 20, and favors or disfavors only the satellite 20 determined by the execution of the special lottery in the bingo game. For example, in a bingo game, the control unit 56 awards a benefit to or imposes a penalty on the satellite 20 associated with the bonus pocket 60 that the ball B has entered. A benefit here might be, for example, declaring that a bingo has been achieved when a player is one number away from bingo, validating multiple numbers displayed on a bingo card regardless of the lottery result, or awarding a bonus game. Meanwhile, a penalty might be, for example, invalidating a number that was valid up to that point or declaring that game to be a loss.

Also, the control unit 56 drives a motor for moving the bonus pockets 60 up and down, thereby controlling the movement of the bonus pockets 60 in a direction intersecting the upper surface 13a of the guide ring 13. The control unit 56 controls the movement of the bonus pockets 60, allowing the bonus pockets 60 to move up or down. Consequently, when the bonus pockets 60 are positioned flush with the upper surface 13a of the guide ring 13 (see FIG. 8), the bonus pockets 60 will not function as a ball catching part. Also, when the bonus pockets 60 are positioned below the upper surface 13a of the guide ring 13 (see FIG. 9), the bonus pockets 60 will function as a ball catching part.

### Flow of Processing

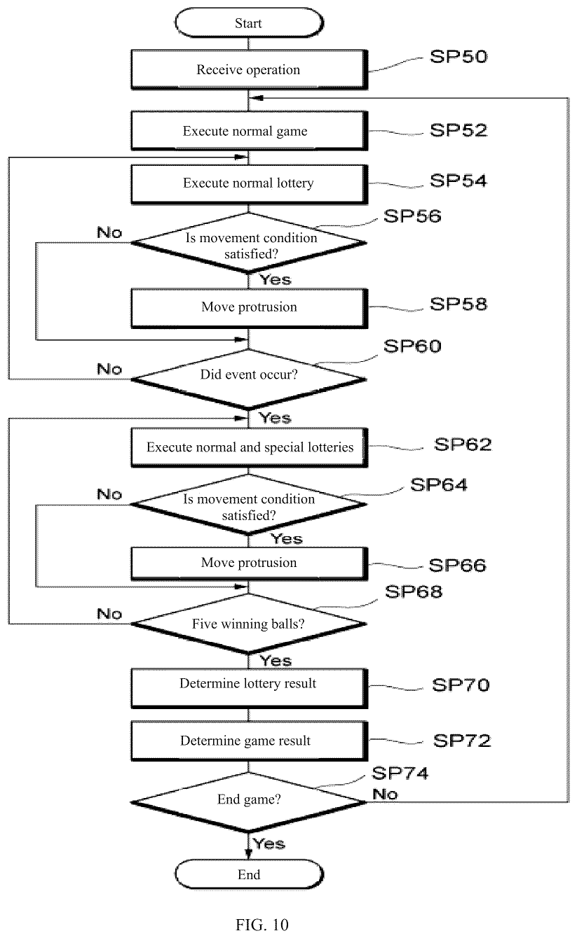

FIG. 10 is a flowchart showing an example of the flow of processing performed by each functional units of the lottery game machine 1A according to the second embodiment. The order and details of the following processing can be changed as needed. In the initial state (at the start of the lottery game) before the processing of FIG. 10, a bingo card is displayed on the display 42A of each satellite 20.

The processing of steps SP50 to SP58 is the same as the processing of steps SP12 to SP18 in the first embodiment, and therefore will not be described again. The processing moves to the processing of step SP60 after the processing of SP58.

### (Step SP60)

The control unit 56 determines whether an event triggering the start of a special game (e.g., a ball B entering a ball pocket 14 with a specific number such as “8” or “16”) has occurred. If the determination is affirmative, the processing moves to the processing of step SP62, and if the determination is negative, the processing returns to the processing of step SP54, and the normal lottery continues.

### (Step SP62)

The lottery unit 54 executes a special lottery that determines the satellite 20 associated with a bonus pocket 60 in parallel with the normal lottery that determines the numbers for the bingo card. When the rotating pinwheel 19 appears, for example, through the movement of the protrusion 16 during the processing of step SP58 or step SP66 (described below), balls B on the turntable 12 may be hit and flicked away by the vanes 16a and 16b of the rotating pinwheel 19, causing the balls B to enter a bonus pocket 60. Additionally, the control unit 56 adjusts the likelihood that the balls B will enter a bonus pocket 60 by moving the bonus pockets 60 up and down or by returning balls B that have entered a bonus pocket 60 back onto the turntable 12. The processing then moves to the processing of step SP64.

### (Step SP64)

The control unit 56 determines whether a movement condition of the protrusion 16 is satisfied. This processing is similar to the processing in step SP56, and a determination is made as to whether the same movement condition as that in step SP56 is satisfied. If, for example, the processing of step SP64 is performed after an affirmative determination in the processing of step SP56, the movement condition in step SP64 may differ from that in the processing of step SP56. For instance, if step SP56 affirmatively determines that the number of balls B on the turntable 12 has decreased to a specific number (e.g., three) or fewer, the processing of step SP64 may determine whether the movement condition is satisfied by a decrease to an even smaller number (e.g., one) than the specific number.

### (Step SP66)

The control unit 56 drives the motor for moving the protrusion 16 up and down, causing the protrusion 16 to move. This processing is the same as the processing in step SP58, and will not be described again. The processing then moves to the processing of step SP68.

### (Step SP68)

The control unit 56 determines whether a total of five balls B have entered the ball pockets 14 and achieved a win. If the determination is affirmative, the processing moves to the processing of step SP70, and if the determination is negative, the processing returns to the processing of step SP62, and the normal lottery and the special lottery continue.

### (Step SP70)

The lottery unit 54 determines the numbers associated with the ball pockets 14 that the balls B entered (the five winning numbers) as the numbers to be activated in the bingo game. Additionally, the control unit 56 controls the ball handling mechanism to collect the balls B that entered the ball pockets 14 and prepares them for the next lottery game. Moreover, the lottery unit 54 determines the satellite 20 associated with the bonus pocket 60 that a ball B has entered as a satellite 20 to be either favored or disfavored in the game result. The processing then moves to the processing of step SP72.

### (Step SP72)

The control unit 56 activates the five numbers determined in the processing of step SP70 on the bingo card displayed on the display 42A of each satellite 20. Additionally, the control unit 56 awards a benefit, such as declaring that a bingo has been achieved when a player is one number away from bingo, for the bingo card displayed on the display 42A of the satellite 20 determined in the processing of step SP70. The processing then moves to the processing of step SP74.

### (Step SP74)

The control unit 56 determines whether a game ending condition is satisfied such as game over. If the determination is affirmative, the processing ends the processing series shown in FIG. 10. If the determination is negative, the processing returns to the processing of step SP52, and the next normal game is carried out.

### Action and Effect

As described above, the lottery game machine 1A serving as the information processing device according to the second embodiment is a lottery game machine 1 that executes a lottery game featuring a ball B fed onto a turntable 12 in response to operation inputs received from players at each of a plurality of satellites 20, and comprises a lottery unit 54 for executing a normal lottery (first lottery) that determines a lottery result shared among all the satellites 20 based on whether the ball B has entered any one of ball pockets 14 or the center pocket 18 (a plurality of holes formed in the turntable 12), and a special lottery (second lottery) that determines the satellite 20 associated with a bonus pocket 60 that the ball B has entered if the ball B has entered one such bonus pocket 60 (satellite hole), with the bonus pockets 60 being formed around the periphery of the turntable 12 and each being associated with a satellite 20; and a control unit 56 that, based on the lottery result of the normal lottery, proceeds all the games corresponding to the satellites 20, and favors or disfavors the game at the satellite 20 determined by the special lottery.

With this configuration, a lottery result shared among all the satellites 20 is determined by a normal lottery, and the shared lottery result is applied to the game at each satellite 20. Also, the satellite 20 associated with the bonus pocket 60 that the ball B has entered is determined by a special lottery, and the game at that determined satellite 20 is favored or disfavored. Consequently, when a normal lottery is executed (in the case of a normal game), the lottery result shared among all the players is applied to the game, whereas when a special lottery is executed (in the case of a special game), the game is favored or disfavored only for a certain player. Thus, the gameplay can vary depending on whether a normal lottery or a special lottery is executed, which prevents the gameplay from becoming monotonous. Furthermore, when a special lottery is executed, it is possible to create a sense of anticipation or anxiety for the players, as only a certain player may be rewarded or penalized. It is therefore possible to enhance the entertainment value of the lottery game.

Also, with the lottery game machine 1A according to the second embodiment, each bonus pocket 60 is disposed near the satellite 20 with which that bonus pocket 60 is associated.

With this configuration, a player can easily determine whether the ball B has entered the bonus pocket 60 associated with one's own satellite 20 by looking at one's own satellite 20.

Also, with the lottery game machine 1A according to the second embodiment, the protrusion 16 that can move in a direction intersecting the upper surface 12a of the turntable 12 is formed in the center of the turntable 12, and the control unit 56 controls the movement of the protrusion 16 in the intersecting direction, and when the protrusion 16 is positioned flush with the upper surface 12a of the turntable 12 by the movement control, the protrusion 16 functions as one of the plurality of holes, and when the protrusion 16 is positioned protruding from the upper surface 12a of the turntable 12 by the movement control, the protrusion 16 does not function as one of the plurality of holes.

With this configuration, moving the protrusion 16 up and down changes whether the protrusion 16 functions as one of the plurality of holes formed in the turntable 12. That is, the center pocket 18 appears and disappears depending on the up and down movement of the protrusion 16, and the result of the lottery changes depending on whether the ball B has entered the center pocket 18. Consequently, the game can unfold in a variety of ways depending on the result of the lottery.

Also, with the lottery game machine 1A according to the second embodiment, the protrusion 16 has a pair of vanes 16a and 16b, and the control unit 56 rotates the protrusion 16 protruding from the upper surface 12a of the turntable 12.

With this configuration, as the protrusion 16 protruding from the upper surface 12a of the turntable 12 rotates, the ball B hits the vanes 16a and 16b of the protrusion 16 and is flicked away. This makes it possible to introduce more variability into the movement of the ball B on the turntable 12, allowing for more diversity in the gameplay. Also, when a ball B hits the vanes 16a and 16b of the projection 16 and is flicked away, the ball B is more likely to enter a bonus pocket 60. This increases the possibility that the game of the satellite 20 associated with the bonus pocket 60 that a ball B has entered will be favored or disfavored, which further heightens the player's sense of anticipation or anxiety.

Also, with the lottery game machine 1A according to the second embodiment, the control unit 56 controls the movement of the bonus pockets 60 in a direction intersecting the upper surface 13a of the guide ring 13 disposed around the turntable 12.

With this configuration, moving the bonus pockets 60 up and down makes it possible to adjust the likelihood that the ball B will enter a bonus pocket 60, allowing for even more varied gameplay.

Also, with the lottery game machine 1A according to the second embodiment, the lottery unit 54 executes a special lottery when a specific execution condition is satisfied during the execution of a normal lottery.

With this configuration, when a specific execution condition such as an event occurrence is satisfied during the execution of a normal lottery in which a shared lottery result is obtained at all the satellites 20, a special lottery is executed to select a satellite 20 at which the game will be favored or disfavored. This creates a sense of exclusivity that the special lottery is something special that is different from a normal lottery.

### MODIFICATION EXAMPLES

The present invention is not limited to the above embodiments. That is, appropriate design changes made to the above embodiments by a person skilled in the art are also encompassed by the present invention, so long as they have the characteristics of the present invention. Also, the elements of the above embodiments and the modification examples given below can be combined to the extent that this is technically possible, and combinations of these are also encompassed by the present invention, so long as they have the features of the present invention.

For instance, with the special lottery in the first embodiment, an example was given of determining the satellite 20 associated with the color of ball B as unique information about the ball B, but this unique information may instead be appearance information such as the size or shape of the ball B, or may be a tag ID (identification information) indicated by the IC tag of the ball B. When this unique information is the tag ID indicated by the IC tag of the ball B, the player cannot visually identify the ball B with the unique information associated with one's own satellite 20 from among the balls B fed on the turntable 12. Consequently, whether a ball B with the unique information associated with the player's own satellite 20 satisfies the lottery condition cannot be predicted by looking at the movement of the ball B on the turntable 12, so the player can derive an unexpected excitement when a lottery result involving the player is obtained.

Also, in the first embodiment, an example was given in which the lottery unit 54 executed a normal lottery in the normal game, and switched from the normal lottery to execute a special lottery in a special game, but the execution timing of the special lottery is not limited to this example. For instance, the timing at which the special lottery is executed may be when an execution condition is satisfied after a specific length of time has elapsed since switching from the normal game to the special game, or when an execution condition is satisfied during the execution of the normal game. Also, when an execution condition is satisfied, the special lottery may be executed in parallel with the normal lottery, rather than switching from the normal lottery.

Also, in the second embodiment, an example was given in which a special lottery was executed in parallel when the execution condition was satisfied in the normal game, but the timing at which the special lottery is executed is not limited to this example. For instance, the timing at which the special lottery is executed may be the point at which the normal game is switched to a special game, or when an execution condition is satisfied after a specific length of time has elapsed since the normal game was switched to the special game. Also, a special lottery may be executed by switching from the normal lottery, rather than being executed in parallel with the normal lottery.

Also, in the above first embodiment, an example was given in which the unique information (color) about the ball B was associated with a satellite 20 and stored in advance, but the lottery game machine 1 may have an association unit for dynamically associating the unique information about the ball B with a satellite 20 at the start of or during the execution of the lottery game. This association unit associates the unique information about the ball B with a satellite 20 at a specific point at the start of or during the execution of the lottery game. The storage unit 50 stores this association information associated by the association unit in the game data 50B. Also, the association unit may perform processing to release the association between the unique information about the ball B and the satellite 20 that had once been associated at the start of or during the execution of the lottery game, and then re-establish an association.

Also, in the above second embodiment, an example was given in which the bonus pockets 60 were associated with the satellites 20 in advance, but the lottery game machine 1A may also have an association unit for dynamically associating the bonus pockets 60 with the satellites 20 at the start of or during the execution of the lottery game. This association unit associates the bonus pockets 60 with the satellites 20 at a specific point at the start of or during the execution of the lottery game. The storage unit 50 stores the association information associated by this association unit in the game data 50B. Also, the association unit may perform processing to release the association between the bonus pockets 60 and the satellites 20 that had once been associated at the start of or during the execution of the lottery game, and then re-establish an association.

Also, in the first and second embodiments, an example was given in which the ball B was automatically fed onto the turntable 12 under the control of the control unit 56, without any operation by the player, but the ball B may also be fed in response to an operation by the player, for example. For instance, the reception unit 52 may receive a feed instruction operation by the player, and the control unit 56 may perform control so as to feed the ball B onto the turntable 12 at the point when this feed instruction operation is received.

Also, in the first and second embodiments, an example was given in which the control unit 56 favored or disfavored only the game of a satellite 20 determined by a special lottery, but the present invention is not limited to this. For instance, the control unit 56 may favor or disfavor a satellite 20 determined by a special lottery to a greater degree than other satellites 20 by making the degree of favor or disfavor of the game of the determined satellite 20 greater than the degree of favor or disfavor of the games of the other satellites 20. For example, the control unit 56 may make the satellite 20 determined by the special lottery the most favored of all the satellites 20 in such a way that if the game of the satellite 20 determined by the special lottery has an increase of 10 pieces of content, the games of other satellites 20 will have an increase of only 5 pieces of content.

Also, in the first and second embodiments, an example was given in which the control unit 56 executed the same game at all of the satellites 20, but the control unit 56 may instead execute a different game at each satellite 20. Even when different games are being played at each of the satellites 20, the control unit 56 applies the lottery result of the normal lottery at those satellites 20, as in the above embodiments, and favors or disfavors the game at the satellite 20 determined by the special lottery. For example, the control unit 56 favors or disfavors only the game at the satellite 20 determined by the special lottery. Also, if there is content or the like shared among the game of all the satellites 20, the control unit 56 may make the satellite 20 determined by the special lottery the most favored of all the satellites 20 in such a way that, if the content is increased by 10 pieces in the game of the satellite 20 determined by the special lottery, the content will increase by only 5 pieces in the game of other satellites 20. Also, the control unit 56 may execute a plurality of different kinds of games at one satellite 20, and based on the lottery result, proceed each of the different games. That is, the control unit 56 may perform control so that a single player can play a plurality of kinds of game (multi-games) that proceed based on the same lottery result.

Also, in the first and second embodiments, an example was given in which the protrusion 16 had a pair of vanes 16a and 16b, but the number of vanes of the protrusion 16 need only be one or more, and may be an odd or even number, and the spacing between the vanes may or may not be equal. Also, so long as an operation allows a ball B on the turntable 12 to be flicked, the protrusion 16 is not limited to rotation, and may be controlled to perform one or more of a variety of movements, including half rotation, pivoting, vibrating, etc.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 1A: lottery game machine (computer, information processing device)
12: turntable (lottery wheel)
14: ball pocket (hole)
16: protrusion
16a, 16b: vane
18: center pocket (hole)
20: satellite
54: lottery unit
56: control unit
B: ball (lottery medium)

What is claimed is:

1. A lottery game machine that executes a lottery game featuring a lottery medium, the lottery game machine comprising:
a plurality of satellites, each of which receives an operation input from a player playing a game;
a lottery board, onto which the lottery medium is fed in response to the operation input received from the satellites, comprising:
ball pockets; and
satellite holes formed in a periphery of the lottery board and respectively corresponding to the satellites; and
a central processing unit (CPU) that:
executes a first lottery that determines a lottery result shared among all the satellites based on whether the lottery medium has entered any one of the ball pockets,
executes a second lottery that determines one of the satellites associated with any one of the satellite holes that the lottery medium has entered,
applies the lottery result of the first lottery to all game settings respectively corresponding to the satellites, and
adjusts, among the game settings, a game setting corresponding to the one of the satellites, to be favored or disfavored.

2. The lottery game machine according to claim 1, wherein
each of the satellite holes is disposed in a vicinity of a corresponding satellite among the satellites.

3. The lottery game machine according to claim 1, wherein
the lottery board comprises a protrusion in a center of the lottery board,
the protrusion is movable in a direction intersecting an upper surface of the lottery board,
the CPU controls movement of the protrusion in the intersecting direction,
in a state where the protrusion is positioned flush with the upper surface of the lottery board, the protrusion functions as one of the ball pockets, and
in a state where the protrusion is positioned protruding from the upper surface of the lottery board, the protrusion does not function as one of the ball pockets.

4. The lottery game machine according to claim 3, wherein
the protrusion has one or more vanes, and
the CPU rotates the protrusion protruding from the upper surface of the lottery board.

5. The lottery game machine according to claim 1, wherein
the CPU controls movement of the satellite holes in a direction intersecting an upper surface of the periphery of the lottery board.

6. The lottery game machine according to claim 1, wherein
the CPU executes the second lottery upon determining that a specific execution condition is met during execution of the first lottery.

7. A non-transitory computer readable recording medium storing instructions for controlling a lottery game machine that executes a lottery game featuring a lottery medium, the lottery game machine comprising: a plurality of satellites, each of which receives an operation input from a player playing a game; a lottery board, onto which the lottery medium is fed in response to the operation input received from the satellites, comprising: ball pockets; and satellite holes formed in a periphery of the lottery board and respectively corresponding to the satellites, the instructions causing the lottery game machine to execute:
executing a first lottery that determines a lottery result shared among all the satellites based on whether the lottery medium has entered any one of the ball pockets;
executing a second lottery that determines one of the satellites associated with any one of the satellite holes that the lottery medium has entered;
applying the lottery result of the first lottery to all game settings respectively corresponding to the satellites, and
adjusting, among the game settings, a game setting corresponding to the one of the satellites, to be favored or disfavored.
